(19) United States
(12) Patent Application Publication
(10) Pub. No.: US 2023/0420927 A1
(43) Pub. Date: Dec. 28, 2023

(54) Electronic cut-off protection device

(71) Applicant: HAGER-ELECTRO SAS, OBERNAI (FR)

(72) Inventor: Benjamin PIDANCIER, SELESTAT (FR)

(21) Appl. No.: 18/036,168

(22) PCT Filed: Nov. 18, 2021
(86) PCT No.: PCT/EP2021/082113

§ 371 Date: May 10, 2023

(30) Foreign Application Priority Data
Nov. 18, 2020 (FR) 2011837

(51) Int. Cl. H02H 3/08; H02H 3/20

(52) U.S. Cl. CPC H02H 3/08; H02H 3/20

(57) ABSTRACT

The invention relates to an electronic cut-off protection device comprising: —a phase power line (L) and a neutral power line (N), —a current sensor (1), —an electronic protection trigger device (2) electrically connected to the current sensor (1) and able and designed to emit a first protection trigger control signal (D1) representing the occurrence of an overload fault, the electronic protection trigger device (2) having a response time of between 10 milliseconds and 1 second, —an electronic cut-off unit (3) comprising at least one electronic cut-off component arranged on the phase power line (L), characterised in that the electronic cut-off device comprises: —an analogue protection trigger device (4) which is configured to receive a signal representing the voltage at the terminals (30, 31) of the electronic cut-off unit (3), and which is connected to the electronic cut-off unit (3) and arranged to compare the signal representing the voltage at the terminals (30, 31) of the electronic cut-off unit (3) with a predetermined threshold value and, if the threshold value is exceeded, emit a second protection trigger control signal (D2) representing the occurrence of an EMC shockwave fault or a short-circuit fault, the analogue protection trigger device (4) having a response time of between 1 microsecond and 10 milliseconds, —in that the electronic cut-off unit (3) is able and designed to be tripped by the first protection trigger control signal (D1) and/or by the second protection trigger control signal (D2) so as to open the at least one electronic cut-off component.

The present invention relates to the field of electronic cut-off protection devices.

In contrast to an electro-mechanical cut-off protection device, an electronic cut-off protection device cannot absorb high values of currents in the case of a short-circuit or EMC shockwave (the acronym EMC meaning Electro-Magnetic Compatibility) without risking damage to the electronic cut-off unit. Thus, the response time for the detection of a short-circuit must be sufficiently short, in other words of the order of a few microseconds, in order to interrupt the current in time. Such an electronic cut-off protection device generally comprises an electronic protection trigger circuit which usually comprises a microcontroller to provide the coordination of the various elements, the measurement, the communication, together with the fault detection. It may therefore potentially also be used to detect fast transient faults, of the short-circuit or EMC shockwave type, as long as they are sufficiently powerful and fast for performing this task.

However, selecting a microcontroller capable of detecting faults that are so fast greatly increases the cost of the electronic cut-off protection device.

The aim of the present invention is to overcome these drawbacks by providing a solution allowing the use of a microcontroller for the detection of faults of the short-circuit or EMC shockwave type to be avoided.

For this purpose, the invention relates to an electronic cut-off protection device comprising at least:
at least one phase current line and a neutral current line,
at least one current sensor capable of and designed to at least measure the current flowing in said at least one phase current line and to generate an acquisition signal representative of the image of the current flowing in said at least one phase current line,
an electronic protection trigger circuit electrically connected with said current sensor and capable of and designed to at least process said acquisition signal and, where appropriate, to generate a first protection trigger command signal representative of the occurrence of a fault of the overload type, said electronic protection trigger circuit having a response time in the range between 10 milliseconds and 1 second,
an electronic cut-off unit comprising at least one power cut-off electronic component respectively disposed on said at least one phase current line, characterized in that said electronic cut-off protection device comprises an analog protection trigger circuit, configured for receiving a signal representative of the voltage across the terminals of the electronic cut-off unit, connected to the electronic cut-off unit, and arranged for comparing the signal representative of the voltage across the terminals of the electronic cut-off unit with a predetermined threshold value and, in the case of said threshold value being exceeded, generating a second protection trigger command signal representative of the occurrence of a fault of the EMC shockwave type or of the short-circuit type, said analog protection trigger circuit having a response time in the range between 1 microsecond and 10 milliseconds,
in that the triggering of said electronic cut-off unit is capable of and designed to at least be controlled by said first protection trigger command signal and/or by said second protection trigger command signal, so as to open said at least one cut-off electronic component,
and in that said electronic cut-off protection device furthermore comprises an electrical power supply configured for supplying the electronic protection trigger circuit and the analog protection trigger circuit.

The invention will be better understood by virtue of the description hereinafter, which relates to several preferred embodiments, given by way of non-limiting examples and explained with reference to the appended schematic drawings, in which:

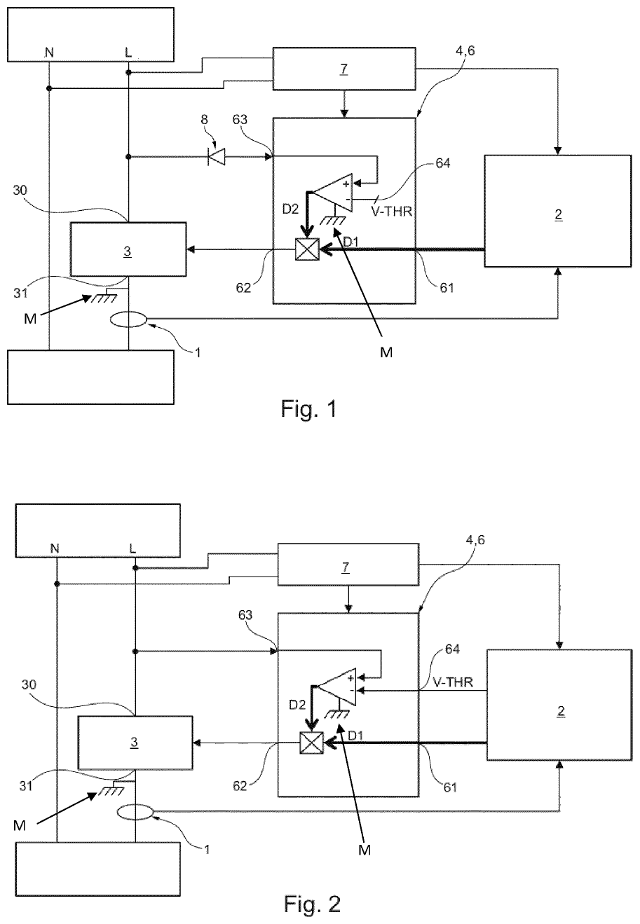

FIG. 1 shows an electrical circuit diagram of the electronic cut-off protection device according to a first possibility of a first variant embodiment of the invention,

FIG. 2 shows an electrical circuit diagram of the electronic cut-off protection device according to a second possibility of the first variant embodiment of the invention,

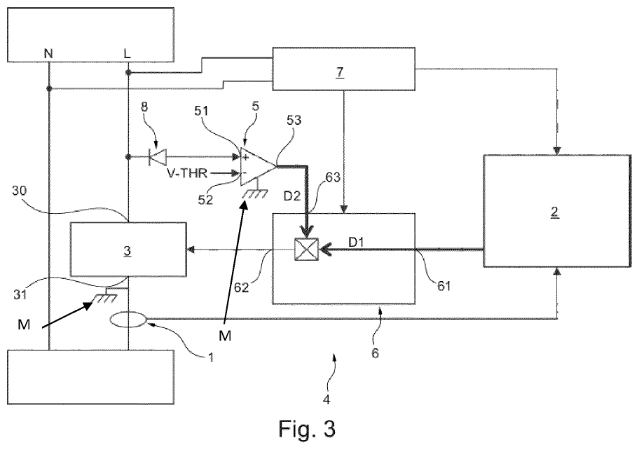

FIG. 3 shows an electrical circuit diagram of the electronic cut-off protection device according to a first possibility of a second variant embodiment of the invention,

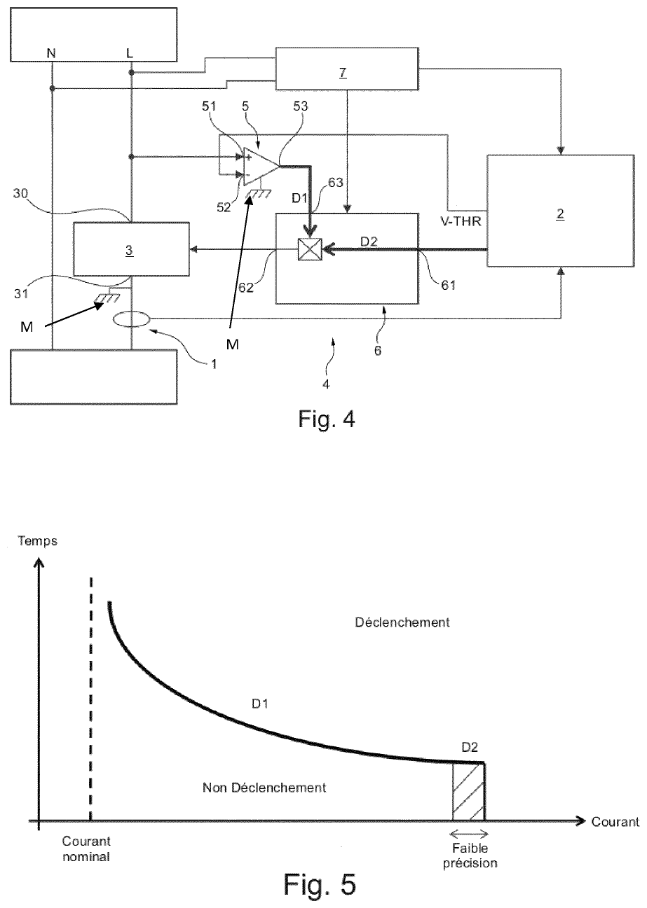

FIG. 4 shows an electrical circuit diagram of the electronic cut-off protection device according to a second possibility of the second variant embodiment of the invention, and

FIG. 5 shows a triggering curve showing the response time of the electronic cut-off protection device according to the invention as a function of the current.

With reference to the figures, an electronic cut-off protection device comprises at least;
at least one phase current line L and a neutral current line N,
at least one current sensor 1 capable of and designed to at least measure the current flowing in said at least one phase current line L and to generate an acquisition signal representative of the image of the current flowing in said at least one phase current line L,
an electronic protection trigger circuit 2 electrically connected with said current sensor 1 and capable of and designed to at least process said acquisition signal and, where appropriate, to generate a first protection trigger command signal D1 representative of the occurrence of a fault of the overload type, said electronic protection trigger circuit 2 having a response time in the range between 10 milliseconds and 1 second,
an electronic cut-off unit 3 comprising at least one power cut-off electronic component respectively disposed on said at least one phase current line L.

According to the invention, said electronic cut-off protection device comprises;
an analog protection trigger circuit 4, configure for receiving a signal representative of the voltage across the terminals 30, 31 of the electronic cut-off unit 3, connected to the electronic cut-off unit 3, and arranged for comparing the signal representative of the voltage across the terminals 30, 31 of the electronic cut-off unit 3 with a predetermined threshold value and, in the case of said threshold value being exceeded, generating a second protection trigger command signal D2 representative of the occurrence of a fault of the EMC shockwave type or of the short-circuit type, said analog protection trigger circuit 4 having a response time in the range between 1 microsecond and 10 milliseconds,
the triggering of said electronic cut-off unit 3 being capable of and designed to at least be controlled by said first protection trigger command signal D1 and/or by said second protection trigger command signal D2, so as to open said at least one cut-off electronic component,
an electrical power supply 7 configured for supplying the electronic protection trigger circuit 2 and the analog protection trigger circuit 4.

Advantageously, the present invention allows two types of fault detection to be implemented in parallel in the same electronic cut-off protection device. The first detection is analog by virtue of the analog protection trigger circuit 4 and is based on the comparison of the voltage of the power cut-off electronic component with a predetermined threshold value; it allows faults in the electrical installation of the short-circuit type or shockwaves caused by lightening to be detected, but also potential failures of the cut-off electronic component, for example a power transistor. The second detection is digital by virtue of the electronic protection trigger circuit and allows faults of the overload type to be detected, based on the measurement of the current in the phase current line L by means of the current sensor 1. More particularly, in order to avoid the need for a high-performance electronic protection trigger circuit 2 having a response time of the order of a microsecond, the idea of the invention is to use the voltage across the terminals 30, 31 of the electronic cut-off unit 3. By comparing this voltage with a predetermined threshold value, it is therefore possible to detect faults of the short-circuit or EMC shockwave type. The simplicity of implementation also enhances the performance of the solution making it fast, reliable and robust.

More particularly, the idea of the invention is to use the drop in the voltage of the cut-off electronic component which is the quasi-linear image of the current Vtransistor=R*I, with R corresponding to the resistance of the cut-off electronic component. Its value depends on the temperature of the component and on the current flowing through it. Indeed, by virtue of this relationship, it is possible to estimate the value of the current I in the phase current line L.

The electronic protection trigger circuit 2 and the current sensor 1 allow the detection of faults of the overload type and form a digital detection chain whose parameters may be customized by the user in order for it to be best adapted to the electrical installation. As is illustrated in FIG. 5, the response time of the electronic protection trigger circuit 2 may be considered as slow, since it is of the order of tens of milliseconds, more particularly in the range between 10 milliseconds and 1 second, but the triggering is effected with a high precision. A ‘high precision’ here means a percentage error in the range between 1 and 5 percent. This digital detection chain may also be used for detecting electric arc faults. Indeed, an electric arc fault detection algorithm could be implemented in the electronic protection trigger circuit 2, as long as there is also a measurement of the voltage between the phase current line L and the neutral current line N. This digital detection chain cannot be used for detecting faults of the short-circuit or EMC shockwave type.

The analog protection trigger circuit 4 allows the detection of a fault of the short-circuit or EMC shockwave type and forms an analog detection chain, with a ‘fast’ response time of the order of the microsecond, more particularly in the range between 1 microsecond and 10 milliseconds, but with a very low precision of the order of 10 A, as is illustrated in FIG. 5, mainly due to the non-linearity of the resistance of the cut-off electronic component R as a function of the current and of the temperature.

In addition to providing the protection of the installation, the present invention also allows a potential failure of said at least one power cut-off electronic component of the electronic cut-off unit 3 to be detected. This is because a significant increase in the resistance of the cut-off electronic component R in the conducting state of the cut-off electronic component is a sign of a failure of the component and will then be detected.

The predetermined threshold value is ideally adjusted to be close to the acceptable current limit of said at least one power cut-off electronic component, in order to provide its protection. The acceptable current limit corresponds to a maximum current defined in the data supplied by the manufacturer of the power cut-off electronic component.

The predetermined threshold value will also preferably need to be sufficiently high in order not to generate spurious triggering events in the electrical installation. In other words, the predetermined threshold value is selected so as not to interfere with the trigger circuit curve chosen by the user.

The shockwave may be a 8/20 microsecond or 1.2/50 microsecond wave.

The current sensor 1 may consist of a measurement shunt or a Rogowski coil or a current transformer or a Hall-effect sensor or similar device.

The electrical power supply 7 may consist of a non-isolated AC/DC converter and be electrically connected in parallel between the phase current line L and the neutral current line N.

Preferably, said at least one cut-off electronic component comprises at least one power transistor, preferably two power transistors. The two power transistors are preferably configured in series, for example inverse connected, on the phase current line L.

For example, this power transistor may consist of a bipolar transistor or a field-effect transistor. It is controlled by the driver 6 described hereinafter in such a manner as to conduct or not conduct the electrical current.

The current sensor 1 is preferably a measurement shunt, situated between the two transistors and preferably connected in series.

Preferably and as is illustrated in FIGS. 1 to 4, said analog protection trigger circuit 4 comprises at least one driver 6, configured at least for controlling said at least one power cut-off electronic component of the electronic cut-off unit 3 and comprising at least a first input terminal 61 electrically connected to the electronic protection trigger circuit 2 and an output terminal 62 electrically connected to the electronic cut-off unit 3.

Advantageously, the driver 6 performs a triggering control function and thus allows said at least one power cut-off electronic component of the electronic cut-off unit 3 to be controlled. In particular, the triggering of said at least one power cut-off electronic component may be controlled by said first protection trigger command signal D1 and/or by said second protection trigger command signal D2, so as to open said at least one cut-off electronic component.

According to a first variant embodiment of the invention and as is the illustrated in FIGS. 1 and 2, the driver 6 furthermore comprises a second input terminal 63 electrically connected to the electronic cut-off unit 3 and the driver 6 is furthermore configured for comparing the signal representative of the voltage across the terminals 30, 31 of the electronic cut-off unit 3 with the predetermined threshold value and, in the case of said threshold value being exceeded, generating said second protection trigger command signal D2.

Advantageously, in addition to the triggering control function, the driver 6 incorporates a comparison function also commonly called protection against de-saturation.

According to a first possibility of the first variant embodiment of the invention illustrated in FIG. 1, the electronic cut-off protection device comprises an electrical circuit for adjusting the predetermined threshold comprising at least a diode 8 so as to allow the adjustment of said predetermined threshold value, said electrical circuit being electrically connected between said second input terminal 63 of the driver 6 and the terminal 30 of said electronic cut-off unit 3. In this case, the driver 6 is configured for generating a voltage which corresponds to the predetermined threshold value.

Advantageously, in this case, this configuration allows the adjustment of the predetermined threshold value. The diode 8 is preferably a Zener diode. This electrical circuit has the advantage of being analog.

According to a second possibility of the first variant embodiment of the invention illustrated in FIG. 2, the driver 6 comprises a third input terminal 64 electrically connected to the electronic protection trigger circuit 2, so as to allow the adjustment of said predetermined threshold value in said electronic protection trigger circuit 2.

Advantageously, in this case, the electronic protection trigger circuit 2 allows the adjustment of the predetermined threshold value electronically.

According to a second variant embodiment of the invention and as is illustrated in FIGS. 3 and 4, said analog protection trigger circuit 4 furthermore comprises at least one comparison unit 5 comprising a first input terminal 51, a second input terminal 52 and an output terminal 53. Said first input terminal 51 is electrically connected to the electronic cut-off unit 3 and said output terminal 53 is electrically connected to a second input terminal 63 that the driver 6 comprises. Moreover, said comparison unit 5 is configured for comparing the signal representative of the voltage across the terminals 30, 31 of the electronic cut-off unit 3 with said predetermined threshold value and, in the case of said threshold value being exceeded, generating the second protection trigger command signal D2.

Advantageously, the comparison unit 5 performs a comparison function. The comparison unit 5 may comprise a comparator.

According to a first possibility of the second variant embodiment of the invention illustrated in FIG. 3, the electronic cut-off protection device comprises an electrical circuit for adjusting the predetermined threshold comprising at least a diode 8 so as to allow the adjustment of said predetermined threshold value, said electrical circuit being electrically connected between said first input terminal 51 of said comparison unit 5 and the terminal 30 of said electronic cut-off unit 3. In this case, the comparison unit 5 preferably comprises a second input terminal 52 connected to a voltage regulator or a voltage divider bridge or equivalent circuit in order to generate the desired voltage which corresponds to the predetermined threshold value.

Advantageously, in this case, this configuration allows the adjustment of the predetermined threshold value. The diode 8 is preferably a Zener diode. This electrical circuit has the advantage of being analog.

According to a second possibility of the second variant embodiment of the invention illustrated in FIG. 4, said second input terminal 52 of said comparison unit 5 is electrically connected to the electronic protection trigger circuit 2, so as to allow the adjustment of said predetermined threshold value in said electronic protection trigger circuit 2.

Advantageously, in this case, the electronic protection trigger circuit 2 allows the adjustment of the predetermined threshold value electronically.

Preferably, the electronic protection trigger circuit 2 according to the invention comprises at least a microcontroller configured at least for processing said acquisition signal representative of the image of the current flowing in said at least one phase current line L and, where appropriate, generating said first protection trigger command signal D1 representative of the occurrence of a fault, the microcontroller having a response time in the range between 10 milliseconds and 1 second.

The microcontroller may also be designed to provide measurement, communication, in addition to the fault detection functions. In any case, it is not designed to detect faults of the short-circuit or EMC shockwave type. Indeed, the latter is not sufficiently powerful and fast for performing this task.

Preferably, the electronic cut-off protection device according to the invention comprises a modular format housing, in other words whose format preferably conforms to the standard UTE C61-920.

The invention thus allows an electronic cut-off protection device to be produced in modular format with a cost and a size that are limited without having to select an electronic protection trigger circuit 2 capable of detecting ‘fast’ faults, which would greatly increase the cost of production.

Preferably, said housing has an overall parallelepipedic shape with a first main face and a second main face, and lateral faces, back, bottom, front and top, respectively, extending from one to the other of the first and second main faces, and with a width, in other words the separation between the first and second main faces, equal to a whole number of times a predetermined distance, called modulus.

Preferably, in the case of detection of a fault by the analog protection trigger circuit 4, the driver 6 is configured for controlling the opening of said at least one power cut-off electronic component of the cut-off unit 3 and for transmitting a signal to the electronic protection trigger circuit 2 in order to inform it of the presence of a fault.

For this purpose, the driver 6 can instantaneously send the control of the electronic component, preferably a transistor, to zero. The driver 6 may also send a signal to the electronic protection trigger circuit 2, preferably a microcontroller, in order to inform it of the presence of a fault.

Preferably and alternatively, in the case of detection of a fault by the analog protection trigger circuit 4, the driver 6 is configured for controlling the opening of said at least one power cut-off electronic component of the cut-off unit 3 and the comparison unit 5 is configured for transmitting a signal to the electronic protection trigger circuit 2 in order to inform it of the presence of a fault.

For this purpose, the driver 6 can instantaneously send the control of the electronic component, preferably a transistor, to zero. The comparison unit may, for its part, send a signal to the electronic protection trigger circuit 2, preferably a microcontroller, in order to inform it of the presence of a fault.

Preferably, the electronic cut-off unit 3 comprises a mass M which is local. Thus, the mass M does not correspond to a mass of the circuit formed by the phase current line L and the neutral current line N.

Preferably, the analog protection trigger circuit 4 comprises a mass M which is local.

Preferably, the comparison unit 5 comprises a mass M which is local.

It goes without saying that the invention is not limited to the embodiments described and shown in the appended drawings. Modifications remain possible, notably from the point of view of the constitution of the various elements or by substitution of technical equivalents, without however straying from the field of protection of the invention.

1. An electronic cut-off protection device comprising at least;
at least one phase current line and a neutral current line,
at least one current sensor capable of and designed to at least measure the current flowing in said at least one phase current line and to generate an acquisition signal representative of the image of the current flowing in said at least one phase current line,
an electronic protection trigger circuit electrically connected with said current sensor and capable of and designed to at least process said acquisition signal and, where appropriate, to generate a first protection trigger command signal representative of the occurrence of a fault of the overload type, said electronic protection trigger circuit having a response time in the range between 10 milliseconds and 1 second,
an electronic cut-off unit comprising at least one power cut-off electronic component respectively disposed on said at least one phase current line, wherein said electronic cut-off protection device comprises an analog protection trigger circuit, configured for receiving a signal representative of the voltage across the terminals of the electronic cut-off unit, connected to the electronic cut-off unit and arranged for comparing the signal representative of the voltage across the terminals of the electronic cut-off unit with a predetermined threshold value and, in the case of said threshold value being exceeded, generating a second protection trigger command signal representative of the occurrence of a fault of the EMC shockwave type or of the short-circuit type, said analog protection trigger circuit having a response time in the range between 1 microsecond and 10 milliseconds,
in that said triggering of the electronic cut-off unit is capable of and designed to at least be controlled by said first protection trigger command signal and/or by said second protection trigger command signal, so as to open said at least one cut-off electronic component,
and in that said electronic cut-off protection device furthermore comprises an electrical power supply configured for supplying the electronic protection trigger circuit and the analog protection trigger circuit.

2. The electronic cut-off protection device as claimed in claim 1, wherein said analog protection trigger circuit comprises at least one driver, configured at least for controlling said at least one power cut-off electronic component of the electronic cut-off unit and comprising at least a first input terminal electrically connected to the electronic protection trigger circuit and an output terminal electrically connected to the electronic cut-off unit.

3. The electronic cut-off protection device as claimed in claim 2, wherein said driver furthermore comprises a second input terminal electrically connected to the electronic cut-off unit and in that the driver is furthermore configured for comparing the signal representative of the voltage across the terminals of the electronic cut-off unit with the predetermined threshold value and, in the case of said threshold value being exceeded, generating said second protection trigger command signal.

4. The electronic cut-off protection device as claimed in claim 3, wherein said electronic cut-off protection device comprises an electrical circuit for adjusting the predetermined threshold comprising at least a diode so as to allow the adjustment of said predetermined threshold value, said electrical circuit being electrically connected between said second input terminal of the driver and the terminal of said electronic cut-off unit.

5. The electronic cut-off protection device as claimed in claim 3, wherein the driver comprises a third input terminal electrically connected to the electronic protection trigger circuit, so as to allow the adjustment of said predetermined threshold value in said electronic protection trigger circuit.

6. The electronic cut-off protection device as claimed in claim 2, wherein said analog protection trigger circuit furthermore comprises at least one comparison unit comprising a first input terminal, a second input terminal and an output terminal, said first input terminal being electrically connected to the electronic cut-off unit and said output terminal being electrically connected to a second input terminal that the driver comprises and in that said comparison unit is configured for comparing the signal representative of the voltage across the terminals of the electronic cut-off unit with said predetermined threshold value and, in the case of said threshold value being exceeded, generating the second protection trigger command signal.

7. The electronic cut-off protection device as claimed in claim 6, wherein said electronic cut-off protection device comprises an electrical circuit for adjusting the predetermined threshold comprising at least a diode, so as to allow the adjustment of said predetermined threshold value, said electrical circuit being electrically connected between said first input terminal of said comparison unit and the terminal of said electronic cut-off unit.

8. The electronic cut-off protection device as claimed in claim 6, wherein said second input terminal of said comparison unit is electrically connected to the electronic protection trigger circuit, so as to allow the adjustment of said predetermined threshold value in said electronic protection trigger circuit.

9. The electronic cut-off protection device as claimed in claim 1, wherein the electronic protection trigger circuit comprises at least a microcontroller configured at least for processing said acquisition signal representative of the image of the current flowing in said at least one phase current line and, where appropriate, generating said first protection trigger command signal representative of the occurrence of a fault, the microcontroller having a response time in the range between 10 milliseconds and 1 second.

10. The electronic cut-off protection device as claimed in claim 1, wherein said electronic cut-off protection device comprises a modular format housing.
